(19) United States
(12) Patent Application Publication
(10) Pub. No.: US 2008/0285308 A1
(43) Pub. Date: Nov. 20, 2008

(54) Light Guide and Apparatus For Using Light Guide

(76) Inventors: Donald Burris Clary, Rancho Palos, CA (US); Solomon L. Katrikh, Los Angeles, CA (US)

Correspondence Address: Lois A Santopietro;E I Du Pont De Nemours And Company, Legal patent Records Center, 4417 Lancaster Pike, Wilmington, DE, 19805, US

(21) Appl. No.: 10/585,686

(22) PCT Filed: Mar. 21, 2005
(86) PCT No.: PCT/US05/09599

§ 371 Date: Jul. 10, 2006

Related U.S. Application Data
(60) Provisional application No. 60/555,664, filed on Mar. 23, 2004.
(60) Provisional application No. 60/575,281, filed on May 28, 2004.

(51) Int. Cl. F21V 11/00

(52) U.S. Cl. 362/619

(57) ABSTRACT

A light guide and associated display having high uniformity of luminance over the entire light guide and display front side are disclosed.

### FIELD OF THE INVENTION

This invention relates in general to a light guide and its use in a display.

### BACKGROUND OF THE INVENTION

Liquid-crystal displays provided with a backlighting mechanism that is thin and which allows for easy viewing of information on a screen are used with recent models of word processors or computers. The backlighting mechanism in common use adopts an “edge lighting” method in which a linear light source such as a fluorescent tube is provided in proximity to one end portion of a transmissive light conducting plate or light guide. The purpose of the light guide in a liquid crystal display backlight is to bring in light from the side, bend it by approximately 90°, and distribute the light uniformly across the rear surface of an LCD. The most common type of devices that operate on the edge lighting method is shown in FIG. 1; wherein the lamp (4) is fixed in its housing (5) and the light from the lamp moves through an edge of the guide (1) a plurality of light diffusing elements are formed in dots or stripes on one face of a light guide (1), which is almost entirely covered with a light diffusing and reflecting plate (3) whereas the opposite face of the light guide (from which light exits) is covered with a light diffusing sheet (2).

In addition, as is often the case today, backlighting devices are driven with a battery and an improvement in the efficiency of conversion from power consumption to luminance is desired. As disclosed in U.S. Pat. No. 5,521,797, to meet this need, it has been proposed that a sheet made of a light-transmissive material that has a multiple of prisms or raised structures having ridgelines at small intervals on the same side in such a manner that said ridgelines are substantially parallel to one another should be provided on the light emitting surface of the backlighting device, whereby the light it emits is provided with sufficient directivity to increase the brightness in a direction normal to the exit face.

However, the sheet itself is poor in lighting diffusing performance, so it does not have sufficient ability to hide the light diffusing elements formed on the light conducting plate and this has caused a problem in that the shape of the light diffusing elements is seen through the sheet. If the shape of the light diffusing elements is seen through the sheet, uniform light emission cannot be achieved.

FIG. 2 as disclosed in U.S. Pat. No. 5,521,797 illustrates a method for partially covering the light guide with a light scattering and transmissive substance and/or a light diffusing and reflective substance in such a way as to provide a uniform luminance distribution device; the partial covering may be in dots (6) as shown in FIG. 2 or 3 or in stripes (7) as shown in FIG. 4 in such a way that the coverage per unit area of the light conducting plate increases progressively with the increasing distance from the light source.

The demand for reducing the thickness of laptop or booktype word processors and personal computers is ever growing today and one of the topics under current review by manufacturers is to adopt even thinner light guide in the backlighting mechanism. However, if one wants to have a uniform luminance distribution throughout the light emissive surface of a very thin light guide (particularly 2 mm or less), the coverage with a light scattering and transmissive substance and/or a light diffusing and reflective substance per unit area of the portion of the light guide which is near the light source must be reduced (otherwise, the brightness of the portion close to the light source will become much higher in the other portions, thus leading to a failure in providing a uniform luminance distribution throughout the emissive surface).

The present invention relates to a backlighting device that utilizes a patterned light guide for use with display panels that illuminates transmissive or semi-transmissive panels from the rear side (including “edge lighting”).

### SUMMARY OF THE INVENTION

The invention relates to a light guide comprising:
a light conducting substrate comprising,
a) a front surface;
b) a back surface; and
c) at least a first edge and a second edge that oppose each other;
   wherein the back surface has disposed thereon light scattering elements;
   wherein the light scattering elements are at least two different sizes to arranged in a pattern possessing at least a first axis of symmetry;
   wherein at least the first edge and second edge receives light from at least a first and second light source; and wherein the light sources are at least substantially parallel to the axis of symmetry.

The invention further relates to a light guide comprising:
a circular light conducting substrate comprising,
a) a front surface;
b) aback surface; and
c) a side surface;
   wherein the back surface has disposed thereon light scattering elements;
   wherein the light scattering elements are at least two different sizes arranged in a pattern possessing at least a first axis of symmetry;
   wherein the side surface receives light from a light source.

The invention also further relates to a light guide comprising:
a light conducting substrate comprising,
a) a front surface;
b) a back surface; and
c) at least a first edge and a second edge that oppose each other;
   wherein the back surface has disposed thereon light scattering elements;
   wherein the light scattering elements are at least two different sizes arranged in a pattern possessing at least a first axis of symmetry;
   wherein at least one of the first and second edges receives light from at least one light source; and
   wherein the at least one light source is at least substantially parallel to the axis of symmetry.

The foregoing general description and the following detailed description are exemplary and explanatory only and are not restrictive of the invention, as defined in the appended claims.

### BRIEF DESCRIPTION OF THE DRAWINGS

The invention is illustrated by way of example and not limited in the accompanying figures.

FIG. 1 illustrates an edge lit device.

FIG. 2 illustrates a light guide.

FIG. 3 illustrates a light guide with progressively increasing coverage.

FIG. 4 illustrates a light guide with progressively increasing coverage.

FIG. 5 illustrates a longitudinal section of a light guide.

FIG. 6 illustrates a perspective view of a backlight device.

FIG. 7 illustrates a longitudinal section of a backlight device.

FIG. 8 illustrates a top view of the back surface of a light.

FIG. 9 illustrates a top view of the back surface of a light conducting substrate having lamps disposed at the edges.

FIGS. 10, 12, 13, 14, 15, 16 illustrate a patterning method in creating a four-fold symmetry pattern.

FIG. 11 illustrates a circular light guide pattern.

FIGS. 17, 18, 21, 22, 23, 24 illustrate a patterning method in creating a four-fold symmetry pattern having predetermined areas.

FIGS. 19, 21, 22, 23, 24 illustrate a top view of artwork for a light guide with a four-fold symmetry pattern with predetermined area, showing pattern corrections to prevent dark corners.

FIG. 20 illustrates imaginary lines and light scattering elements.

FIG. 21 illustrates modification of the dot pattern to keep the corner from being dark.

FIG. 22 illustrates the end dot creation (the diagonal line), which is the ending point for the two triangle corrections.

FIG. 23 shows the upper left triangle modification, which is the Autocad tangent function applied to the beginning and ending dot sizes of the upper left triangle.

FIG. 24 shows the lower right triangle modification, which is the Autocad tangent function applied to the beginning and ending dot sizes of the lower right triangle.

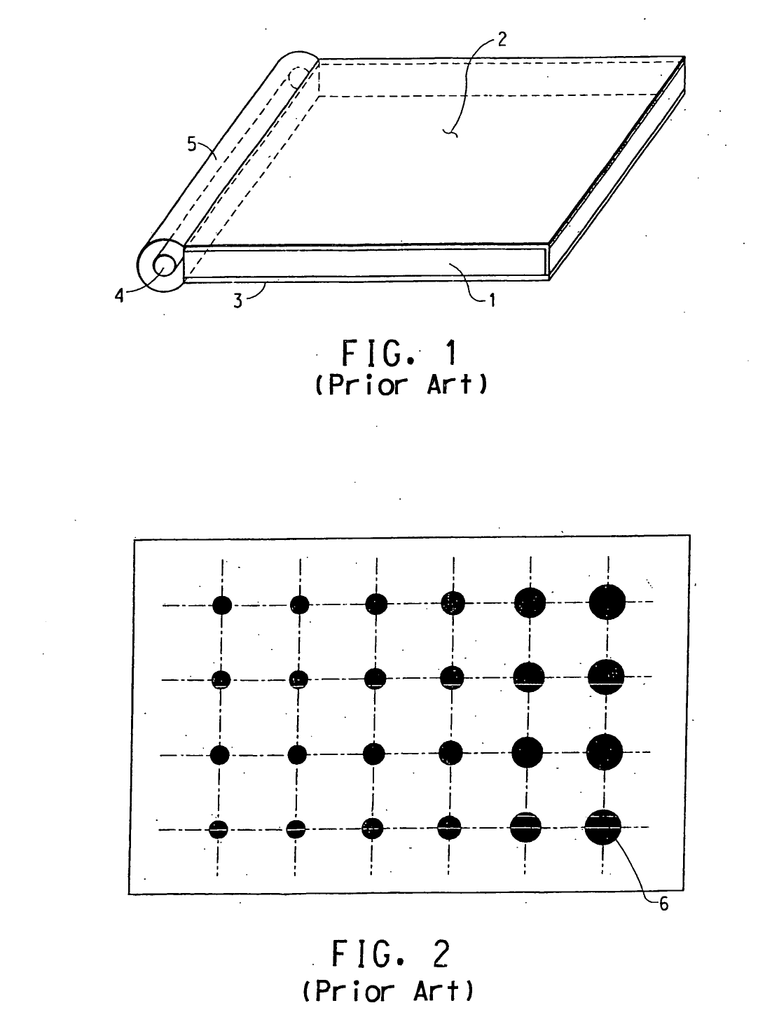

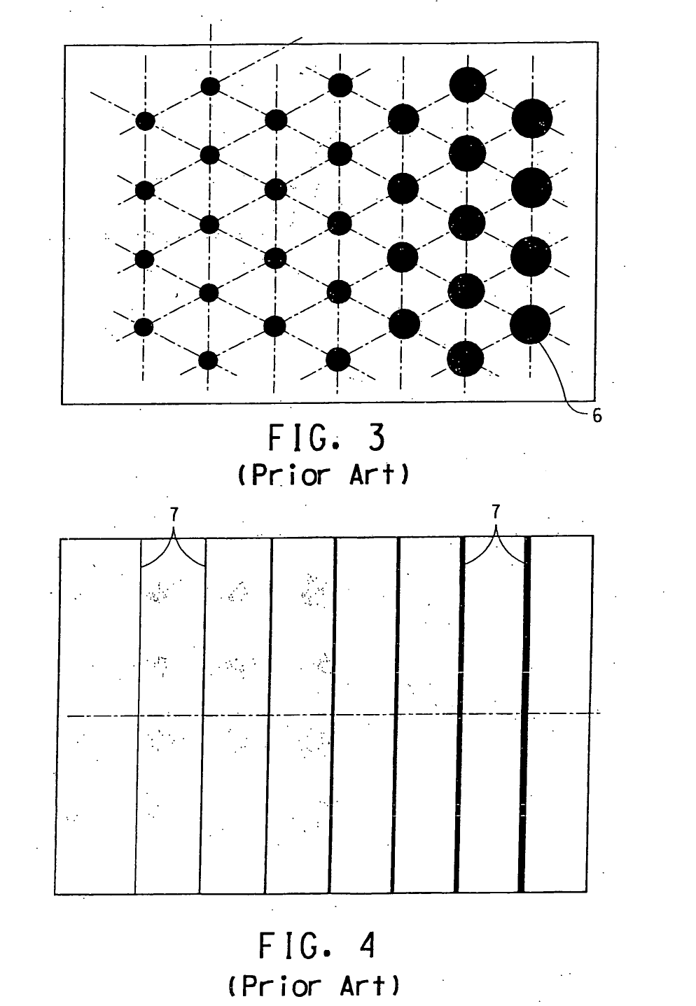

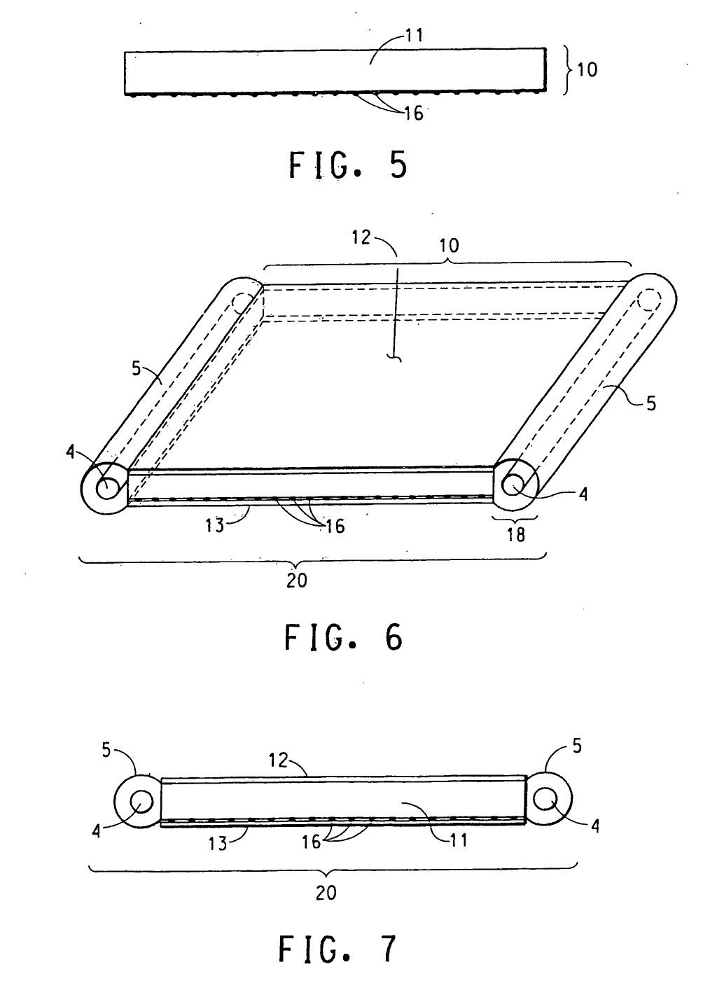

### GLOSSARY OF TERMS

Display—can be any light-transmitting device that has a light guide as a component. Some illustrative non-limiting examples include: plasma displays, liquid crystal displays (active, passive, thin-film transistor, metal-insulator-metal, plasma addressed liquid crystal, ferroelectric), light emitting diode displays, and flat panel displays.

Light source—can be any light source that produces light and most often is visible to the human eye. Some illustrative non-limiting examples include: LEDs (light emitting diodes), incandescents (light bulbs), EL (electro-luminescent), vacuum fluorescent, cold cathode fluorescent lamps.

Light guide—A light guide is a light conducting structure having light scattering elements disposed on a light conducting substrate that transports light from a light source into the light guide, bends the light rays and distributes the light across the rear surface of a display. Synonymous with the phrase “wave guide”.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements, but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of ‘a’ or ‘an’ are employed to describe elements and components of the invention. This is done merely for convenience and to give a general sense of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

### DETAILED DESCRIPTION OF THE INVENTION

The present invention is described below in detail with reference to accompanying drawings.

FIG. 5 is a longitudinal section of a light guide 10 according to an embodiment of the present invention that is comprised of a light conducting substrate 11 bearing light scattering elements 16 on one side of the light conducting substrate 11. The light scattering elements are also considered as light diffusing elements. FIG. 6 is a perspective view of a backlighting device 20 comprising a light guide 10 according to an embodiment of the present invention that adopts an “edge lighting” (18) method, and FIG. 7 is a longitudinal section of this backlighting device 20.

The light conducting substrate 11 of the light guide of this invention can be made of any material that exhibits transparency or semi-transparency and is capable of light transmission. Suitable materials include, but are not limited to, quartz, glass, or light transmissive resins (e.g., acrylic or polycarbonate). A non-limiting example of a specific acrylic resin that is suitable is polymethyl methacrylate (PMMA).

The light guide of this invention can have any desired geometric shape. In certain embodiments, the light guide has a shape selected from conical, pyramidal, cylindrical, circular, triangular and polygon prismatic (e.g., rectangular prismatic), polygon solid (e.g., rectangular solid or square solid). The light guide may have an irregular shape.

Indicated by 16 in FIGS. 5, 6 and 7 are light scattering elements that permit the rays of light incident on the light guide from the edge portion of its side to exit from one of the two major surfaces (front side and backside) of the light guide. The front side is considered the viewing side. The areas 16 can be formed on the surface of the light conducting substrate 11 by various methods. Illustrative, non-limiting methods that are suitable include the following: a) media applications such as paints or printing inks that may contain a light scattering element (e.g., silica, barium sulfate, magnesium oxide, aluminum oxide, titanium oxide, titanium white, calcium carbonate, glass beads, and/or resin beads) dispersed in a light-transmissive substance (e.g., an epoxy resin, an acrylate ester resin, or a vinyl resin) are screen-printed or silk-screened or ink-jet or otherwise printed in various patterns as paint or ink areas on the back surface of the light guide; b) the areas 16 can be roughened areas produced during injection molding, sand blasting, etc.; c) the areas 16 can be made with small holes or projections which may be made during injection molding; and d) the areas 16 may be made by cutting the back surface of the light guide to produce a profile having steps formed therein. Illustrative non-limiting examples of suitable paints include white paint and white epoxy.

Suitable patterns for the areas 16 include, but are not limited to, dots (filled circles), filled stars, filled polygons (e.g., filled squares, filled rectangles, filled triangles), and filled irregular shapes. The term ‘size’ for an area 16 is intended to mean the diameter of a dot, the larger diagonal of a filled rectangle, and the diameter of a circle which would enclose an opening of any other shape, including irregular shapes. The size for an area 16 in this invention can range from about 0.01 inch (0.254 mm) to about 0.7 inch (17.78 mm).

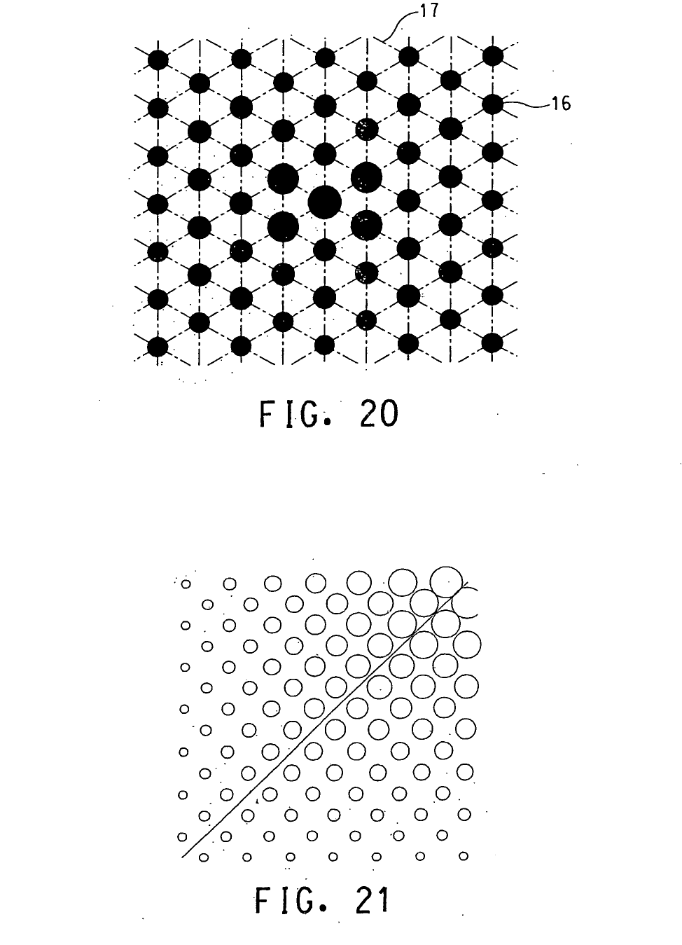

The term “imaginary lines that would be drawn when the light scattering elements 16 are formed on the light guide substrate” means those imaginary lines which serve as a reference for positioning the light scattering elements 16 to be formed on the light conducting substrate by any one of the ordinary methods described hereinabove. An example of these imaginary lines is shown in FIG. 20, in which numeral 16 designates light scattering elements, and 17 refers to the imaginary lines under consideration. That is, in the case where the light scattering elements of the dot-type are formed on the light conducting substrate, the imaginary line would be drawn by connecting the centers of most adjacent dots which have the shortest distance between the centers thereof, as shown in FIG. 20.

Shown by 4 in FIGS. 6 and 7 are two light sources, which may be linear light sources, and, in one embodiment, the light sources are covered with light reflectors 5 in such a way as to provide a certain clearance between the light source outer surfaces and the inner surfaces of the reflector. Each light reflector has a slit for admitting light to be incident on an end portion of the light guide; the reflectors are formed of a specular reflective sheet typically made of Ag, Al or the like, or the reflectors may be formed of a light reflective polymeric film (e.g., polytetrafluoroethylene (PTFE) or polyethylene terephthalate (PET)) sheet that is given light scattering quality by treatment with BaSO4, TiO2, air bubbles or the like. The light sources 4 are provided in proximity to at least one set of opposing end face portions of the light conducting substrate of the light guide in such a way that their central axes are substantially parallel to either end face of the light conducting substrate. Linear light sources may be selected from among various types including a fluorescent lamp (e.g., a cold cathode fluorescent lamp (CCFL)), a tungsten incandescent tube, an optical rod and an array of Light emitting diodes (LEDs). From the viewpoint of lower power consumption, it is best that the length of the portion capable of uniform light emission except the electrode portion is substantially equal to the length of the end portion of the light guide in proximity to that emitting portion.

A preferably diffuse or specular reflective sheet 13 as shown in FIGS. 6 and 7 is provided in such a way as to cover substantially all of the face of the light conducting substrate on which the light scattering elements 16 are formed. The sheet 13 is typically made of Ag or Al, or is a polymeric film (e.g., PET) reflective sheet which is given light diffusing quality by treatment typically with BaSO4, TiO2 or air bubbles.

Shown by 12 in FIGS. 6 and 7 is a sheet that is made of a light-transmissive material and it has a multiple of parallel prisms or raised structures that have straight ridgelines and which are formed at small intervals on the same side. The sheet 12 is provided on the exit face of the light guide 10 in such a way that the ridgelines will face outward (to the side opposite the side facing the light guide). The shape of the prisms is in no way limited and they may be of such a shape that the oblique sides of an individual prism differ in length.

As one aspect of this invention, the light guide 10 of the present invention can be combined with a sheet 12 as described supra to produce a display apparatus that is characterized in that at least one light transmissive sheet is provided on the exit face of the light guide. The sheet, if it is provided in this manner, changes the directivity of the light issuing from the exit face of the display apparatus in such a way that the directivity of light in directions close to a line dropped perpendicular to the exit face is enhanced; as a result, one can fabricate a display device that achieves efficient conversion from power consumption to luminance.

In contrast to the teachings of U.S. Pat. No. 5,521,797, the angle that the imaginary lines (as defined supra connecting the closest to each other light scattering elements) make with the projection of ridgelines of the light transmissive sheet 12 having a multiple of parallel prisms or raised structures is not particularly limited and can range from 0 to 360 degrees.

The light transmissive sheet may be made from any light transmissive material without limitation. Examples of suitable materials include, but are not limited to, polymethacrylate esters, polycarbonates, polyvinyl chloride, polystyrenes, polyamides, polyesters, polyethylenes, polypropylenes, cellulosic resins, glass, etc. Commercially available prismatic films can be utilized as the light transmissive sheet 12. Some commercial films that are suitable include, but are not limited to, brightness enhancement films (BEFs) supplied by 3M, Saint Paul, Minn. and collimating film (CF) supplied by Reflexite Corporation, Avon, Conn.

If necessary or desired, a light diffusing sheet(s) may also be provided in this display apparatus in addition to or in place of the light transmissive sheet(s) 12. One or more light diffusing sheets can be added to the display apparatus. Suitable locations for adding light diffusing sheet(s) include, but are not limited to, a) between the light guide and the light transmissive sheet 12 and b) on the opposing side of the light transmissive sheet 12 away from the light guide.

Also, if necessary or desired, a recirculating polarizer may be provided in this display apparatus. A recirculating polarizer is a polarizer that transmits one component of polarized light and reflects back the other component (rather than the other component being absorbed as is the case with use of a conventional polarizer). When used in this manner in a display device, the reflected component of polarized light can be made to recirculate through the light guide where its polarization will change such that some portion of the recirculated light will now pass through the recirculating polarizer and the rear polarizer of a liquid crystal display (LCD) to increase brightness of the display device without increasing power consumption.

The type of recirculating polarizer useful in this invention is not limited. Illustrative, non-limiting examples include those described in U.S. Pat. Nos. 6,104,455 and 5,751,388, which are incorporated by reference. Certain films that are commercially available are useful as recirculating polarizers. A non-limiting example is dual brightness enhancement film (DBEF) supplied by 3M Corporation, Saint Paul, Minn.

The above described light transmissive sheet(s) 12, diffuser(s), and recirculating polarizer(s) may be used alone or in any combinations with the light guide in a display apparatus according to this invention. Furthermore additional layers serving various functions may be added without limitation to the display apparatus of this invention.

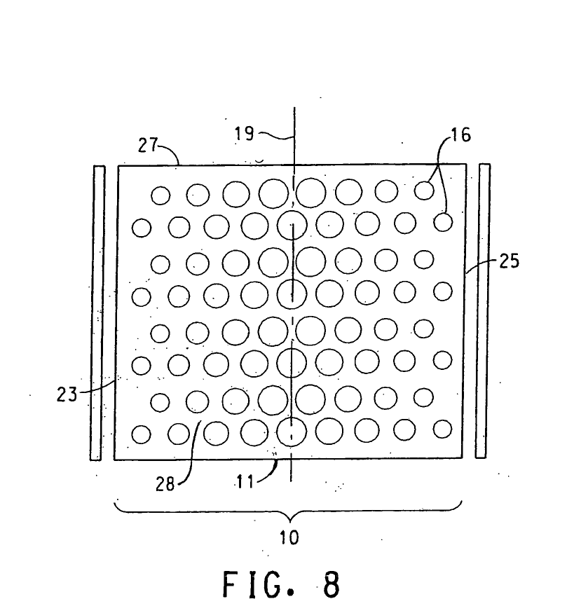

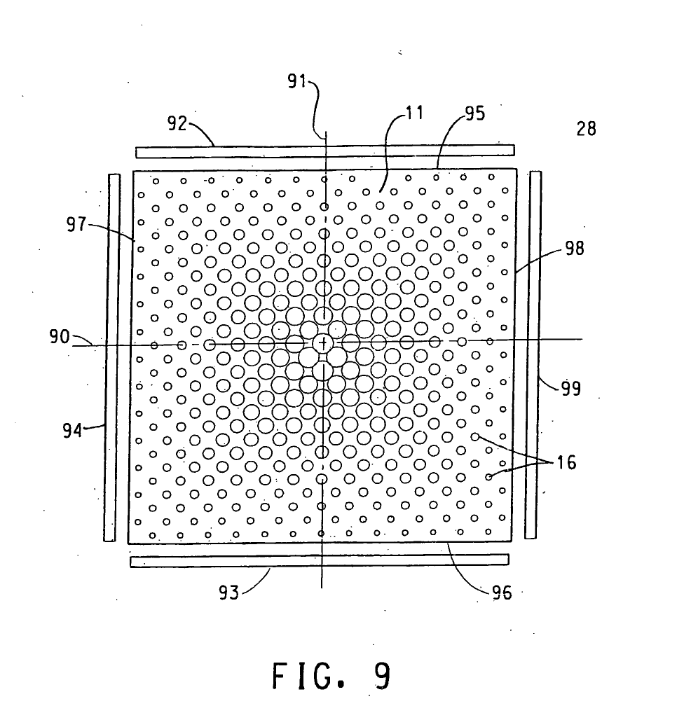

FIG. 8 illustrates an embodiment of the light guide of this invention that is designed for use in displays having lamps on two sides of the light guide and having a pattern of light scattering elements 16 that is characterized to possess a first axis of symmetry (19) and the light guide receives light from at least two light sources, wherein the light sources are at least substantially parallel to the axis of symmetry. More specifically, FIG. 8 illustrates a schematic top view for this embodiment of the back surface 28 of the light conducting substrate 11 of the light guide 10 of this invention, the back surface having a pattern of light scattering elements 16 (e.g., dots, which are represented by circles as shown in this figure). This light guide is for use in displays having two lamps positioned on opposing sides of the light guide and parallel to the axis of symmetry. Only a relatively small number of circles are shown to illustrate schematically this pattern; in practice for a light guide of the invention, the number of light scattering elements 16 on the back surface of the light guide is much larger and the size of the circles is much smaller.

The pattern of light scattering elements 16 as shown in FIG. 8 possesses a first axis of symmetry 19, which is substantially midway between the first and second edges of the light guide. Therefore, the light scattering pattern of FIG. 8 would be superimposed on the back surface of the guide shown as dots (16). Line 23 represents the intersection of the first edge with the back surface of light guide 10; line 25 represents the intersection of the second edge with the back surface of light guide 10. Similarly lines 27 and 11, respectively, represent intersections of two other edges (in case of the guide being a rectangular solid) with the back surface 28 of the light guide.

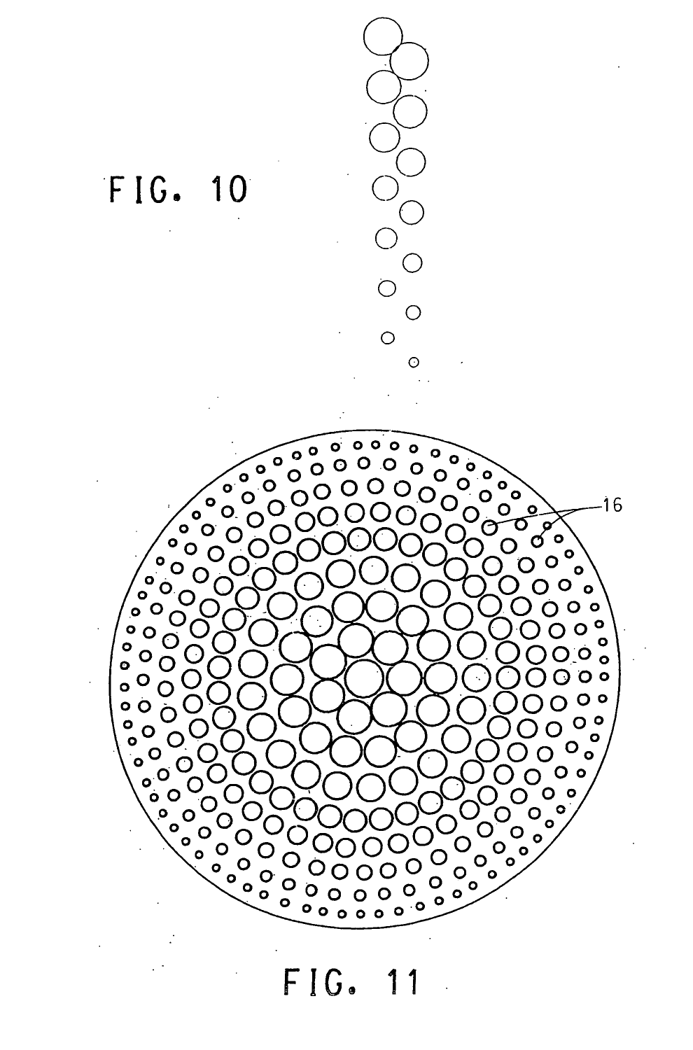

FIG. 9 illustrates an embodiment of the light guide edges of this invention that is designed for use in displays having lamps on four edges of the light guide (top, bottom, right, and left sides). More specifically, FIG. 9 illustrates a schematic top view for this embodiment on the back surface of the light conducting substrate 11 of the light guide of this invention, the back surface having a pattern of light scattering elements 16 (e.g., dots, which are represented by circles as shown in FIG. 9). This embodiment of the light guide is for use in displays having at least four lamps positioned on two pairs of opposing sides of the light guide (which are pair one (top and bottom sides [92, 93]) and pair two (right and left sides [94, 99]) as shown in FIG. 9). Only a relatively small number of circles are shown in FIG. 9 to illustrate schematically this pattern; in practice for a light guide of the invention, the number of light scattering elements 16 on the back surface of the light guide is much larger, wherein the sizes of the circles is much smaller.

The pattern of light scattering elements 16 as shown in FIG. 9 possesses a first axis of symmetry 90 and a second axis of symmetry 91.

The first axis of symmetry (90) is at least substantially midway between the first and second edges of the substrate 11. The second axis of symmetry is substantially midway between the third and fourth edges of the substrate 11. Line 95 represents the intersection of the first edge with the back surface of light guide 10; line 96 represents the intersection of the second edge with the back surface of light guide 10. Similarly lines 97 and 98, respectively, represent intersections of two other edges (third and fourth edges, in case of the guide being a rectangular solid) with the back surface of the light guide.

A description of a process to make a guide with four-fold symmetry is described below. First a basic pattern is created as given in FIG. 10, which is an empirical determination to get the largest and smallest dot sizes. Then one uses the tangent function of AutoCad to get the sizes of the intermediate dots. Subsequently the basic pattern is repeated in an offset structure resulting in the illustration of FIG. 10.

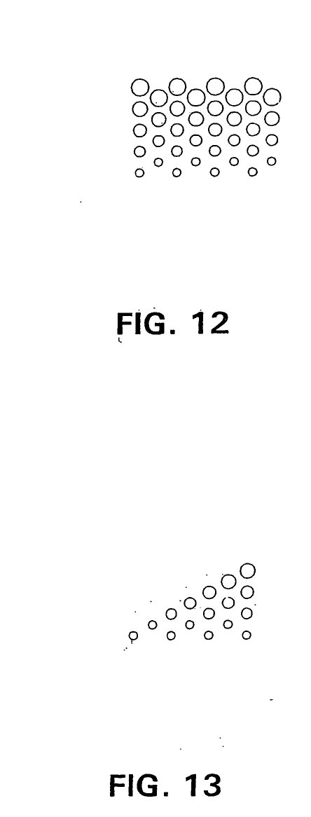

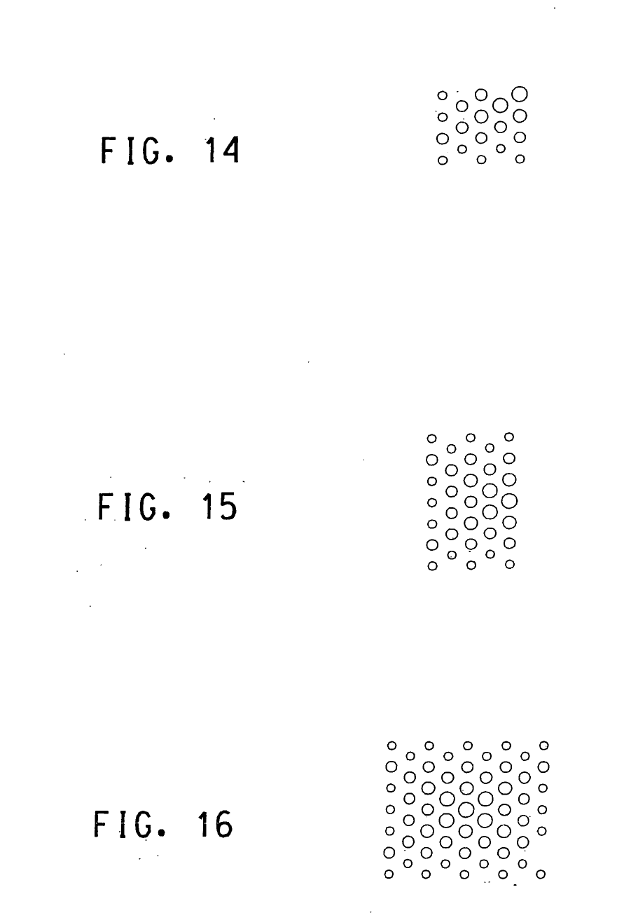

FIG. 12 illustrates using the array command of AutoCad to copy the array to the right. The dot array of FIG. 12 is divided at a 45° angle with a line. The resulting upper left triangle is erased resulting in the illustration found in FIG. 13.

When one mirrors this pattern, to get ¼ of the final pattern, this is what one gets as shown in FIG. 14.

Now one mirrors FIG. 14 resulting in the illustration of FIG. 15.

Now one mirrors FIG. 15 and the final pattern is illustrated in FIG. 16.

FIG. 16 illustrates the largest dots at the center, with dots getting smaller toward the edges. The overall dot pattern has four-fold symmetry.

FIG. 19 illustrates another embodiment of the light guide of this invention that is designed for use in displays having lamps on four sides of the light guide (top, bottom, right, and left sides as shown in FIG. 19). The major portion of the pattern of light scattering elements in this embodiment is the same as for that described in the immediately preceding embodiment (see FIG. 16) except that portions of the pattern of artwork for this latter embodiment in a pre-determined area around points (as defined infra) have been erased and replaced with new patterns (as described infra).

This embodiment is especially useful for light guides having mechanical ears that bolt to front and back metal frames and position the light guide and optical films. When these ears are present, one usually has to use shorter lamps on the sides than would otherwise be desired. Also, each end of a CCFL (which is a typically used lamp) has cathodes where no light is emitted. The combination of the ears and the cathodes result in undesirable dark areas in the corners of a display that is edge lit with lamps (e.g., CCFLs). This embodiment minimizes or eliminates these undesirable dark areas. The dark areas become the predetermined areas on the light guide which are corrected by utilizing a selected light scattering element pattern as discussed below.

More specifically, FIG. 19 illustrates a schematic top view of the back surface 28 of the light conducting substrate of the light guide 10 in this embodiment, the back surface having a pattern of light scattering elements 16 (e.g., dots, which are represented by circles as shown in this figure). This embodiment of the light guide is for use in displays having at least four lamps positioned as pairs on opposing sides of the light guide (which are pair one (top and bottom sides) and pair two (right and left sides) as shown in FIG. 19). Only a relatively small number of circles are shown to illustrate schematically this pattern; in practice for a light guide of the invention, the number of light scattering elements 6 on the back surface of the light guide is much larger and the size of the elements are much smaller.

The pattern of light scattering elements 16 as shown in FIG. 19 possesses a first axis of symmetry 90 and a second axis of symmetry 91. The intersection of the first axis of symmetry 90 with the second axis of symmetry 91 is a midpoint 130.

The first axis of symmetry is substantially midway between the first and second edges of the light guide 10. The second axis of symmetry is substantially midway between the third and fourth edges of the light guide 10. Line 95 represents the intersection of the first edge with the back surface 28 of light guide 10; line 96 represents the intersection of the second edge with the back surface 28 of light guide 10. Similarly lines 97 and 98, respectively, represent intersections of two other edges (third and fourth edges, in case of the guide being a rectangular solid) with the back surface 28 of the light guide. The intersection of line 95 and line 97 is point 140. The intersection of line 95 and line 98 is point 142. The intersection of line 96 and line 98 is point 144. The intersection of line 96 and line 97 is point 146.

With reference to FIG. 19, (150, 152, 154 and 156) represent predetermined areas moving away from the points 140, 142, 144 and 146, respectively, for this embodiment. The predetermined areas may be selected empirically by visual inspection of one skilled in the art. In these predetermined areas, the original dot patterns for the previous embodiment are erased in the artwork for the light guide(s) and replaced with new dot pattern(s), which are characterized in that, for a predetermined area moving away from the points, the light diffusion elements decrease from a maximum size adjacent to the edges to a minimum size for a pre-determined distance from the point.

In FIG. 19, the predetermined areas 150, 152, 154 and 156 are shown as squares but they can be any geometrical shape, including irregular shapes, without limitiation. They can be any size with respect to the overall size of the light guide without limitation beyond the size of the light guide.

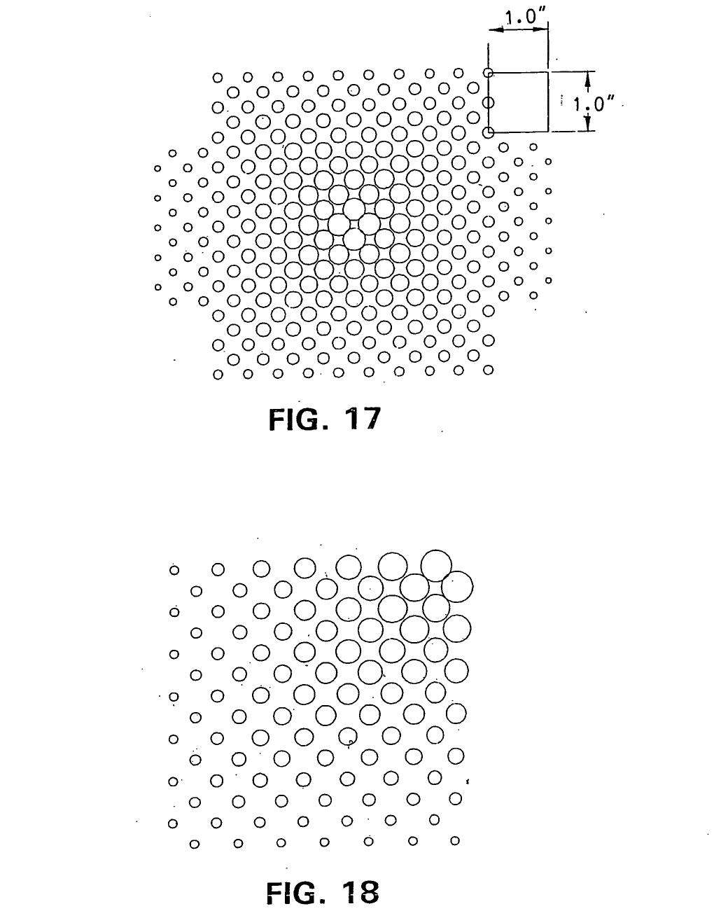

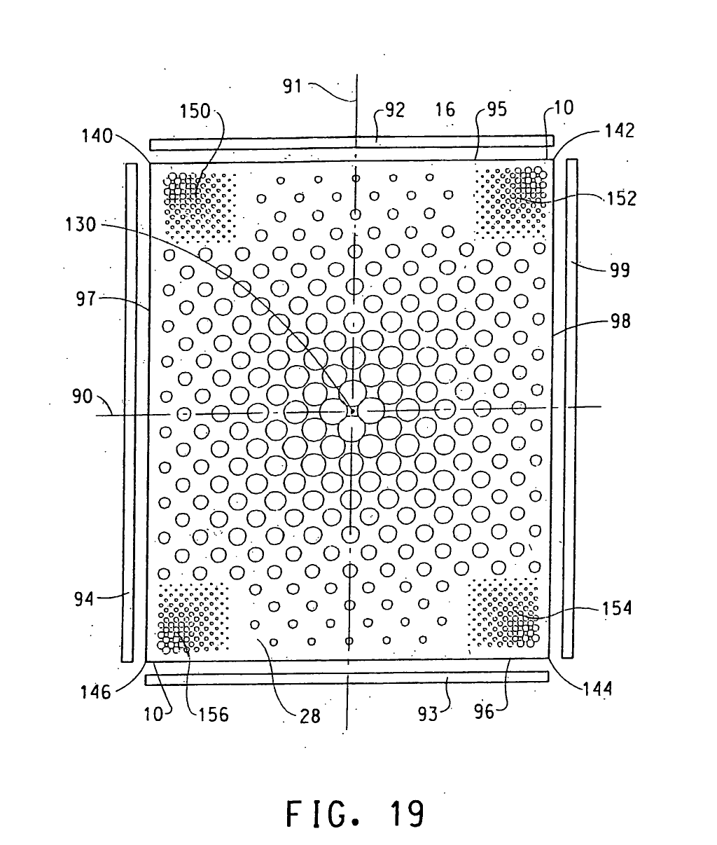

FIG. 18 illustrates schematically a dot pattern that is suitable as replacement dot patterns for the predetermined areas that are erased in the artwork as illustrated in FIG. 17.

In this embodiment, the details for forming initially a dot pattern of the type shown schematically in FIG. 9 and having a first axis of symmetry 90 and a second axis of symmetry 91 are the same as described supra in the immediately preceding embodiment and with reference to FIGS. 10 and 12-16 and hence are not repeated. The final pattern (as shown schematically) having four-fold symmetry for the immediately preceding embodiment is shown in FIG. 16. As illustrated in FIG. 16, this pattern having four-fold symmetry is characterized in that the light diffusing elements for a pre-determined distance increase from a minimum size adjacent to the edges to a maximum size at substantially the intersection of the axes of symmetry. Only the additional details for forming the new dot patterns in the predetermined areas are described below starting with a pattern having four-fold symmetry as illustrated in FIG. 16.

The pattern having four-fold symmetry as shown in FIG. 16 corresponds to a square. In cases where a rectangular-shaped guide is desired, one trims off equal amounts of one set of opposing sides of the square to afford a rectangular pattern of artwork.

One then erases the pattern of light diffusing elements within pre-determined areas moving away from the points (e.g., erases dots within squares as illustrated in FIG. 17) in the artwork for this embodiment.

Next one creates new patterns of light diffusing elements within pre-determined areas of the artwork moving away from the edges that result in the points characterized in that for a pre-determined area moving away from the edges of the points the light diffusion elements decrease from a maximum size adjacent to the edges to a minimum size for a pre-determined distance from the point. As one non-limiting example, the pre-determined areas can be circular dots and have a pattern as illustrated in FIG. 18.

Computer software (e.g., AutoCad) can be employed to assist in creation of the pattern(s) of light diffusing elements within the pre-determined areas. There results a final artwork for this embodiment of the light guide having four-fold symmetry and having predetermined areas moving away from the corners of the artwork. This artwork is then used together with silk screening or ink jet printing or the like to create this pattern of light diffusing elements on the light guide of this embodiment using the steps as disclosed above.

Table 1 illustrates practical examples of light guide dot pattern characteristics. The data offers desirable nearly uniform brightness for the displays that the inventive light guides are utilized in.

TABLE 1
Light Guide Dot Pattern Characteristics¹ Affording Desirable Nearly
Uniform Brightness² for the Inventive Displays

| | | | Dot Diameter | |
|---|---|---|---|---|
| Light | | Guide | center | edge |
| Guide^{2,4} Number | Description and Display Size | Thickness | dot | dot |
| Guide 1 | ARTWORK, 6.3″ LCD SM | ¼″ | .050″, | .024″ |
| Guide 2 | ARTWORK, 6.5″ LCD SM | ¼″ | .065″, | .042″ |
| Guide 3 | ARTWORK. 8.4″ LCD SM | ¼″ | .065″, | .042″ |
| Guide 4 | ARTWORK, 10.4″ LCD SM | ⅛″ | .050″, | .017″ |
| Guide 5 | ARTWORK. 10.4″ LCD | 3/16″ | .050″, | .022″ |
| Guide 6 | ARTWORK, 10.4″ LCD | ¼″ | .050″, | .025″ |
| Guide 7 | ARTWORK, 10.4″ LCD | ¼″ | .050″, | .025″ |
| Guide 8 | ARTWORK, 10.4″ LCD | ¼″ | .050″, | .025″ |
| Guide 9 | ARTWORK, 10.4″ LCD | ¼″ | .050″, | .025″ |
| Guide 10 | ARTWORK, 10.4″ LCD | ½″ | .050″, | .028″ |
| Guide 11 | ARTWORK, 12.1″ LCD | ¼″ | .050″, | .028″ |
| Guide 12 | ARTWORK, 15″ LCD SM³ | ¼″ | .050″, | .018″, .018″ |

¹The pitch (distance between adjacent dot centers) of the dot pattern for each of these light guides was 0.067 inch. Every guide except for the last one (15″ LCD SM) had lamps on two sides of the guide. The last one had lamps on four sides of the guide.
²Each of the above guides for use in LCDs (liquid crystal displays) was designed on purpose to have a dot pattern so that the center of the LCD was slightly brighter (by approximalely 10-30%) than the perimeter.
³The last guide (15″ LCD SM) in Table 1 is one designed for an edge lighling system consisting of a pair of lamps injecting light into each of the four sides of the light guide (8 lamps total). In this guide, there is a faint X pattern of brightness that extends from the four corners to the center of the display. This is a consequence of the merging of light from the sides and the top and bottom of the guide.
⁴In all guides listed in Table 1 except the 15″ one (last guide listed), the center is slightly (15% to 20%) brighter than the edge. But since the human eye can't see differences of less than about 40%, the difference is not observable by a person and can only be detected by a photometer. The 15″ guide with lamps on 4 sides has uniformity⁵ of 1:1.4 due to the effect of merging light from two directions in the corners. This effect of merging does not exist in guides with lamps on only two sides.
⁵Uniformity is defined to be maximum luminance divided by minimum luminance. For the case of the 15″ guide and display (last one in Table 1), the maximum luminance was 800 nits at the center and the minimum luminance was 571 nits at the edges. Thus the uniformity was 800 nits/571 nits = 1 to 1.4 or 1:1.4.
⁶While not being bound by any theory, the following is an explanation of what the inventor(s) believe may be significant factor(s), such that two of the displays shown in Table 1 can have dot center diameters greater than 0.055 inch, i.e., the 6.5″ and 8.4″ guides with center dot diameters of 0.065 inch. This center dot size and uniformity worked only because these guides are quite small. The inventor(s) think that light from the edges is scattering and filling the usually dark center. The edge light is only a short distance from the center on these small size displays. When the inventor(s) tried to use this large 0.065 center dot in larger size guides, the center area went very dark. They believe this is due to the center being too far away from the edges in larger size guides for the edge light scattering to fill the center area.
KEY: ″ = inch(es)

### EXAMPLES

### General

The procedures, methodology and steps described below were used in fabricating the lightguides of these examples and apparatus comprising the lightguides.

The light conducting substrates of the lightguides were fabricated from poly(methyl methacrylate) (PMMA). The PMMA used was either Plexigas G supplied by Atoglas of Atofina Chemicals, Inc. (Philadelphia, Pa.) or Acrylite GP supplied by CYRO Industries (Rockaway, N.J.).

Light conducting substrates of the desired shape and dimensions were fabricated using standard machining techniques.

Artwork for each inventive display pattern was, obtained using the general methods and techniques as described above in the “detailed description” section of this disclosure.

The material used for the light scattering elements of the light guides was a white epoxy. More specifically, the white epoxy was Enthone.omi white 50-100NM #20 catalyst supplied by Enthone-OMI, Inc., a subsidiary of ASARCO, (New Haven, Conn.).

For each light guide described in these examples, the desired pattern of light scattering elements of the above white epoxy was applied to the light conducting substrate by standard silk screening techniques using the desired artwork pattern for each of the light guides. The silk screening method was a general method known in the art and it was used to apply the patterns, which was done by Hytech Processing, Inc. (Inglewood, Calif.), a silk screen company.

The lamps used in the display apparatus of these examples were cold cathode fluorescence lamps (CCFLs) and were supplied by Stanley Electric Sales of America, Inc., Opto-Electronic Components, (Irvine, Calif.).

The specular reflective sheets were supplied by 3M Corporation, (Saint Paul, Minn.).

The lamp reflectors were supplied by Quality Fabrication, Inc., (Chatsworth, Calif.).

The diffuser(s) were Kimoto diffusers, Kimoto Tech, (Cedartown, Ga.).

The light transmissive sheet(s) were brightness enhancement films (BEF III) supplied by 3M Corporation, (Saint Paul, Minn.).

The recirculating polarizer was dual brightness enhancement film (DBEF) supplied by 3M Corporation, (Saint Paul, Minn.).

The liquid crystal (LC) units, including a liquid crystal layer, front polarizer, and rear polarizer, were supplied by NEC Corporation, (Tokyo, Japan).

### Example 1

This example illustrates a light guide and associated apparatus designed for use with lamps located on two opposing edges of the guide and the dot pattern having an axis of symmetry parallel to the lamps.

This light guide was made as described above starting with a light conducting substrate having a diagonal length of 6.5 inches and a thickness of 0.22 inch. The length and width were 6.99 inches and 4.95 inches, respectively. The inlet edge of the light guide was polished to afford a glossy finish. The inlet edge was polished, more specifically, using first 400, then 600, and finally 1200 grit sandpapers. Next this surface was polished with Novus #2 polish. The resulting light guide exhibited enhanced performance.

The center dot diameter was 0.065 inch and the edge dot diameter was 0.042 inch. The pitch of the dot pattern in this example was 0.067 inch. The pattern of dots (as light scattering/diffusing areas) was that illustrated schematically in FIG. 8. The dot pattern of this light guide was designed on purpose to have a dot pattern such that the center of the LCD was slightly brighter (by approximately 10-30%) than the perimeter.

The resulting light guide was incorporated into an “edge lit” display using components as described above and having the following layers in sequence from back to front (front being the viewing side):

Diffuse reflective layer

Light guide

Diffuser

BEF layer

BEF layer

DBEF layer

LCD (including rear polarizer, liquid crystal layer, and front polarizer)

The two BEF layers were oriented such that projections of the prismatic ridge lines of one BEF layer made angles of approximately 90° with respect to the ridge lines of the other BEF layer. One of the two BEF layers was placed in the above-described layered structure such that imaginary lines (connecting most adjacent dots of the dot pattern) and projections of the ridgelines of this prismatic BEF layer made angles of approximately 0°, 45° and 45°.

This “edge lit” display also had two sets of two opposing CCFL lamps on two sides of the light guide along with associated lamp reflectors.

Within the detection limits of the human eye, this display exhibited uniform luminance over the entire display.

### Example 2

This example illustrates a light guide and associated apparatus designed for use with lamps located on four edges of the guide as opposing pairs of lamps, and the pattern having two axes of symmetry with each pair of lamps having a parallel axis of symmetry.

This light guide was made as described above starting with a light conducting substrate having a diagonal length of 15 inches and a thickness of 0.25 inch. The length and width were 13 inches and 9.125 inches, respectively. The center dot diameter was 0.05 inch and the edge dot diameter on both sets of opposing edges was 0.021 inch. The pitch of the dot pattern in this example was 0.067 inch. The pattern of dots (as light scattering elements) was illustrated schematically in FIG. 9.

The resulting light guide was incorporated into an ‘edge lit’ display using components as described above and having the following layers in sequence from back to front:

Diffuse reflective layer

Light guide

Diffuser

BEF layer

BEF layer

DBEF layer

LCD (including rear polarizer, liquid crystal layer, and front polarizer)

The two BEF layers were oriented such that projections of the prismatic ridge lines of one BEF layer made angles of approximately 90° with respect to the ridge lines of the other BEF layer. One of the two BEF layers was placed in the above-described layered structure such that imaginary lines (connecting most adjacent dots of the dot pattern) and projections of the ridgelines of this prismatic BEF layer made angles of approximately 0°, 45° and 45°.

This “edge lit” display also had two sets of four opposing CCFL lamps on four sides of the light guide along with associated lamp reflectors.

Within the detection limits of the human eye, this display exhibited uniform luminance over the entire display.

### Example 3

### Prophetic

This example will illustrate a light guide and associated apparatus designed for use with lamps on two opposing edges of the guide.

The methodology, materials and details of this example will be carried out in the same manner as for Example 1 except that pitch between adjacent dots will be varied instead of dot size. More specifically, the pitch between adjacent dots near an edge of the light guide will be larger than that near the center of the light guide. A constant dot size of 0.05 inch will be used.

Within the detection limits of the human eye, it is prophesized that this display will exhibit uniform luminance over the entire display.

### Example 4

### Prophetic

This example will illustrate a light guide and associated apparatus designed for use with lamps on four sides of the guide.

The methodology, materials and details of this example will be carried out in the same manner as for Example 2 except that pitch between adjacent dots will be varied instead of dot size. More specifically, the pitch between adjacent dots near an edge of the light guide will be larger than that near the center of the light guide. A constant dot size of 0.05 inch will be used.

Within the detection limits of the human eye, it is prophesized that this display will exhibit uniform luminance over the entire display.

### Example 5

This example illustrates that a light guide having a non-polished edge on the edge that the light enters the guide.

The methodology, materials and details of this example were carried out in the same manner as for Example 1 except that the inlet edge of the substrate was not polished. The resulting light guide exhibited a decrease of about 6-8% in luminance performance.

### Example 6

This example illustrates a light guide and associated apparatus designed for use with lamps positioned on four sides of the guide and having pre-determined areas at the corners of the guide having different patterns of light diffusing elements which corrects the dimness at the corners which was created by the cathode light guide ear arrangement as discussed previously herein.

The light guide was made as described above starting with artwork designed for a light conducting substrate having a length of 12.104 inches and a width of 12.104 inches. Artwork was made corresponding to a pattern of dots having four-fold symmetry (see FIG. 16) that was to be applied to the rear surface of the light conducting substrate as described above using AutoCad software to design artwork for the silk screening application of the dots. The center dot diameter was 0.05 inch and the edge dot diameter on both sets of opposing edges was 0.021 inch. The pitch of the dot pattern in this example was 0.068 inch. The pattern of dots (as light scattering elements) was that illustrated schematically in FIG. 16.

There were 179 dots and 178 spaces on each of the two 12.104 inch sides of this light conducting substrate at this point.

Next two opposing sides of artwork for the light conducting substrate were trimmed to change the shape of the back surface of the light conducting substrate from being square to rectangular. More specifically, artwork for the light conducting substrate was trimmed to equal extents on one set of opposing sides to afford new artwork for a light conducting substrate having a length of 12.104 inches and a width of 9.112 inches. There were now 179 dots and 178 spaces along the lengthwise line of dots and 135 dots and 134 spaces along the width-wise line of dots. The center dot size and dot size along the outer width line remained at 0.050 inch and 0.221 inch, respectively. The dot size along the outer length line was now 0.0282 inch.

Next, as illustrated in FIG. 17, the pattern of dots in the artwork within one inch squares corresponding to each of the four points (corners) of the back surface of the light guide were erased. This afforded an artwork pattern as illustrated in FIG. 17. A new dot pattern was created to replace the now blank one-inch squares in the final artwork as described below.

More specifically, the new dot pattern used in the corners resembles what was done in the center of the guide. The pattern increases brightness in the corners. Somewhat exaggerated, FIG. 18 shows an illustration of the upper right hand corner.

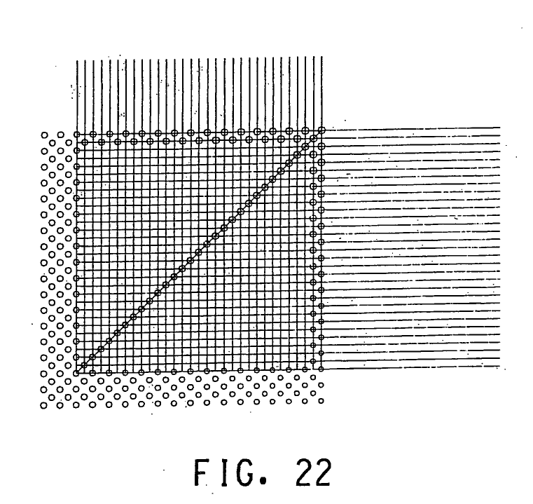

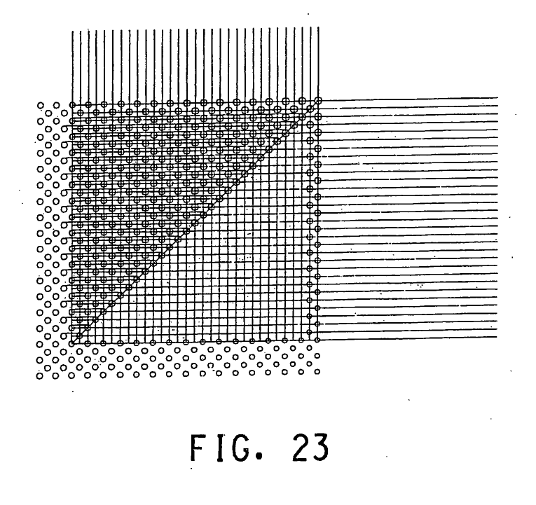

However, there were complications in getting to this pattern. First, any changes had to be made gradual, not abrupt, or else the light uniformity would have suffered. Thus a tangent function in the AutoCad software was used to make gradual changes. However, the starting dot size on the top left was a different dot size (0.0260″) than on the bottom right side (0.0210″), so the corner squares were divided into two triangle areas as shown in FIG. 21.

Next the upper right corner dot diameter was set by empirical experience at being 0.0320″. (More specifically, the 4 corners of the display had to have larger area dots to compensate for the darkening effect of light guide mounting ears and two non-emitting cathodes in the corners. The darkened areas were only about a 1″ square in each corner. It was known that the dots about 1″ from the corners were 0.026″ (upper left) and 0.021″ (lower right). Several trial experiments were run to determine luminance uniformity with gradually increasing dot size in the 1, squares. It was found that 0.320″ dots were enough larger to correct for this luminance loss in the corners.) 30 Tangent functions were made for the 30 rows of dots in the upper left triangle. All 30 functions were different, since there were different starting and ending diameters. In addition, 30 more tangent functions were created on the lower right triangle, which were all different. But first, however, the ending dots along the diagonal were created.

It was known at this point that the lower left dot was 0.0260″ and the upper right corner dot was 0.0320″, and that there were 30 ending dots. Incremental dot size difference was determined as follows: one divided the dot diameter difference over 30 dots (0.0320−0.0260=0.060)/30 dots, or 0.002″ increase per dot. Each dot was then manually drawn (0.0260, 0.0262, 0.0264, 0.0266, etc.) to form the ending dots on a diagonal as shown in FIG. 22.

At this point the starting and ending dots were defined for the 60 tangent functions that were next created.

Tangents in the upper left triangle were next created as shown in FIG. 23.

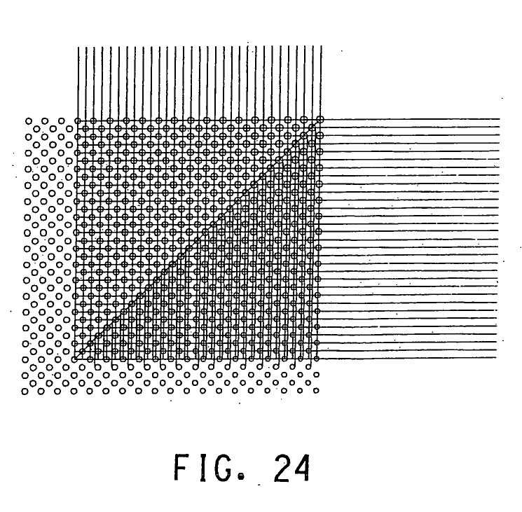

Next the 30 tangents in the lower right triangle were created as shown in FIG. 24.

Now that the upper right corner pattern was completed, this pattern was next mirrored 3 more times at the other three points (corners) to complete the final artwork for the light guide of this example. The artwork was used together with silk screening as described supra to imprint this pattern of dots on the back surface of the light conducting substrate having ears to afford the light guide of this example, which has ears.

The resulting light guide was incorporated into an “edge lit” display using components as described above and having the following layers in sequence from back to front:

Diffuse reflective layer

Light guide

Diffuser

BEF layer

BEF layer

DBEF layer

LCD (including rear polarizer, liquid crystal layer, and front polarizer)

The two BEF layers were oriented such that projections of the prismatic ridge lines of one BEF layer made angles of approximately 90° with respect to the ridge lines of the other BEF layer. One of the two BEF layers was placed in the above-described layered structure such that imaginary lines (connecting most adjacent dots of the dot pattern) and projections of the ridgelines of this prismatic BEF layer made angles of approximately 0°, 45° and 45°.

This “edge lit” display also had two sets of four opposing CCFL lamps on four sides of the light guide along with associated lamp reflectors.

Within the detection limits of the human eye, this display exhibited uniform luminance over the entire display including at the four corners of the display.

### Example 7

### Prophetic

This example will illustrate a cylindrically shaped light guide and associated apparatus designed for use with curved lamps which wrap around the guide.

The methodology, materials, and details of this example will be carried out in the same general manner as for the earlier prophetic examples, except that a cylindrically-shaped light conducting substrate will be used in place of the non-cylindrical substrates of the earlier prophetic examples.

A cylindrically shaped light conducting substrate will be fabricated from PMMA and it will possess a front surface (planar), a back surface (planar), and a side (curved) surface. A dot pattern having circular symmetry (as illustrated in FIG. 11) will be imprinted on the back surface of this substrate to afford a cylindrically shaped guide. The dot pattern of this cylindrically-shaped guide will be such that the smallest dots will be along the circular edge (perimeter) of the back surface (see FIG. 11) while so the largest dots will be substantially at the center of the circle defining the circular edge of the back surface (see FIG. 11).

A display comprising a curved CCFL and this Cylindrically shaped guide together with the other components of Example 1 will be assembled. The curved CCFL will wrap around at least substantially all of the side is surface of cylindrically shaped guide.

It is prophesized that the resulting display will exhibit uniform luminance over the entire display screen.

What we claim is:

1. A light guide comprising:
a light conducting substrate comprising,
a) a front surface;
b) a back surface; and
c) at least a first edge and a second edge that oppose each other;
wherein the back surface has disposed thereon light scattering elements;
wherein the light scattering elements are at least two different sizes arranged in a pattern possessing at least a first axis of symmetry;
wherein at least the first edge and second edge receives light from at least a first and second light source; and wherein the light sources are at least substantially parallel to the axis of symmetry.

2. The light guide of claim 1 wherein the light scattering elements increase from a minimum size adjacent to the edges to a maximum size at the axis of symmetry.

3. The light guide of claim 1 wherein the first edge and the second edge comprise a first pair of edges; and further comprising a third edge and a fourth edge which oppose each other and comprise a second pair of edges; wherein the edges of each pair are at least substantially parallel to each other, and midway between the edges of the first pair, the first axis of symmetry is formed, and midway between the edges of the second pair, a second axis of symmetry is formed, wherein the first and second axes intersect at an intersection, and wherein the light scattering elements increase from a minimum size adjacent to the edges to a maximum size at least substantially at the intersection of the axes of symmetry.

4. The light guide of claim 1 wherein the first edge and the second edge comprise a first pair of edges; and further comprise a third edge and a fourth edge which oppose each other and comprise a second pair of edges; wherein the edges of each pair are substantially parallel to each other; wherein the edges of the first and second pair intersect to form points; and midway between the edges of the first pair the first axis of symmetry is formed, and midway between the edges of the second pair, a second axis of symmetry is formed, wherein the first and second axes intersect at an intersection, and wherein the light scattering elements for a pre-determined distance at the edges increase from a minimum size adjacent to the edges to a maximum size at least substantially the intersection of the axes of symmetry; and for a pre-determined area moving away from the points the light scattering elements decrease from a maximum size adjacent to the points to a minimum size for a pre-determined distance moving away from the points.

5. A light guide comprising:
a circular light conducting substrate comprising,
a) a front surface;
b) a back surface; and
c) a side surface;
wherein the back surface has disposed thereon light scattering elements;
wherein the light scattering elements are at least two different sizes arranged in a pattern possessing at least a first axis of symmetry;
wherein the side surface receives light from a light source.

6. The light guide of claim 5 wherein the light scattering elements increase from a minimum size adjacent to the side surface to a maximum size at least substantially the axis of symmetry.

7. The light guide of claim 1 wherein the light scattering elements are in the size range of 0.015 to 0.07 inch.

8. The light guide of claim 1 wherein the light source is a cold cathode fluorescent lamp.

9. The light guide of claim 1 wherein the light conducting substrate is poly(methyl methacrylate).

10. A display comprising the light guide of claim 1.

11. A display comprising the light guide of claim 5.

12. The light guide of claim 1 wherein at least the first and second edges are polished.

13. The light guide of claim 5 wherein the side surface is polished.

14. The light guide of claim 1 wherein the light scattering elements are formed with methods selected from media applications, producing roughened areas, cutting back areas, and making holes and projections.

15. A display comprising the light guide of claim 1 and at least one layer selected from light transmissive sheet, recirculating polarizer, diffuser, polarizer, liquid crystal layer, and reflector layer.

16. The display of claim 15 wherein the recirculating polarizer is a dual brightness enhancement film.

17. The display of claim 15 wherein the light transmissive sheet is a brightness enhancement film.

18. A light guide comprising:
a light conducting substrate comprising,
a) a front surface;
b) a back surface; and
c) at least a first edge and a second edge that oppose each other;
wherein the back surface has disposed thereon light scattering elements;
wherein the light scattering elements are at least two different sizes arranged in a pattern possessing at least a first axis of symmetry;
wherein at least one of the first and second edges receives light from at least one light source; and
wherein the at least one light source is at least substantially parallel to the axis of symmetry.
